(19) United States
(12) Patent Application Publication
(10) Pub. No.: US 2006/0204924 A1
(43) Pub. Date: Sep. 14, 2006

(54) Cartridge for storing and applying a mass

(75) Inventors: Klaus Galehr, Schlins (AT); Maylin Roth-Wachter, Vaduz (LI); Petra Kropp, Werdenberg (CH); Frank Muller, Feldkirch (AT)

Correspondence Address: John C. Thompson, 69 Grayton Road, Tonawanda, NY, 14150, US

(73) Assignee: Ivoclar Vivadent AG

(21) Appl. No.: 11/240,427

(22) Filed: Sep. 30, 2005

(30) Foreign Application Priority Data
Mar. 14, 2005 (DE) 10 2005 011 643.4

(51) Int. Cl. A61C 5/04

(52) U.S. Cl. 433/90

(57) ABSTRACT

A cartridge for storing and applying a mass, especially a mass of dental material, includes a tube-shaped base body having a first cylindrical portion and a second bent portion and an extrusion spout. A load engaging element cooperates with an extrusion drive device that can be activated to perform an extrusion operation in which the mass in the cartridge is extruded from the extrusion spout. The cartridge also includes an axially displaceable piston disposed in the base body and operable to be displaced by operation of the extrusion drive device such that the piston, as it moves relatively within the first cylindrical portion and the second bent portion of the base body, pushes the mass out of the base body into the extrusion spout and therebeyond. The inner diameter of the extrusion spout is smaller than the inner diameter of the base body and the piston is at least partially bendable.

### CROSS-REFERENCE TO RELATED APPLICATIONS

This application claims foreign priority benefits under 35 U.S.C. §119 from German patent application Ser. No. 10 2005 011 643.4 filed Mar. 14, 2005.

### TECHNICAL FIELD

The present invention relates to a cartridge for applying a mass, in particular, a dental mass, via an extrusion device in which the cartridge can be deployed in the form of a one-time use product.

### BACKGROUND OF THE INVENTION

Cartridges for applying a mass are widely deployed and have been developed in numerous configurations.

Problems that can frequently occur with cartridges of this type include the problem that the mass received by the cartridge cannot be fully extruded therefrom, especially if the extrusion spout of the cartridge extends downwardly at an angle from a base body of the cartridge.

U.S. Pat. No. 5,938,439 discloses a special piston which ensures that, as the occasion arises, it is nonetheless possible to provide a complete extrusion of material, wherein the front portion of the piston is elastically deformable and is thus in a position to fully extrude the mass out of the cartridge.

It is desirable to be able to use the same extrusion drive device to extrude various amounts of dental material. In this connection, it has been proposed to accommodate the length of the base body of the cartridge to the mass extrusion requirements. In connection with the extrusion of a relatively small amount of dental mass, a cartridge can be correspondingly provided with a comparatively short base body while, in connection with the extrusion of a relatively large amount of dental mass, a cartridge having a considerably larger length can be deployed. The pistons comprise, in connection with such cartridges, diameters that are substantially constant, and the cartridges are held via a retaining collar in a corresponding extrusion drive device that operates as a load engaging element.

In the event that the cartridge has a long base body, the piston must travel along a relatively long path through the base body. If, in connection with such a long base body, the front portion thereof is configured in an elastic configuration, the long base body can accept the considerably reduced diameter of the release spout; however, the risk exists that the front region of such a long base body has already been laterally clamped and compromised so that the respective cartridge cannot be used at all or cannot be used to fully extrude the retained mass.

In order, as well, to deliver the dental mass in deep-lying and difficult to access areas, it is advantageous if the extrusion spout comprises a significantly reduced diameter. In this event, the inner diameter of the extrusion spout can, for example, amount to solely one-fifth of the inner diameter of the base body.

Furthermore, it has been proposed to deploy a comparatively shorter piston in a bent base body of a cartridge. A cartridge of this type permits the desired extension of the extrusion spout downwardly.

However, it is problematic that the piston or the base body of the cartridge has a tendency to become tilted or inclined, especially upstream of the location at which the downtapering diameter region of the base body of the cartridge extends into the extrusion spout. As a result of this tilting, on the one hand the sealed-off condition between the piston and the base body no longer exists and, on the other hand, the piston, during such tilting, tends to be subjected to a clamp situation that makes the cartridge unusable.

In fact, the piston can, in principle, be extended. However, the piston would then no longer extend properly within the bent base body of the cartridge.

If, on the other hand, the piston itself exhibits an arcuate form, the danger exists that, if additional measures are not instituted, the piston turns so that a clamping danger is again more likely. In this connection, it is not surprising that a solution of this type has not found wide acceptance.

### OBJECTS AND SUMMARY OF THE INVENTION

The present invention offers a solution to the challenge of providing a cartridge for extruding a mass whereby the cartridge can be produced in various sizes and can be operated in a simple and reliable manner to extrude material therefrom without making more difficult the task of lowering the extrusion spout in an ergonomically favorable manner.

In accordance with the present invention, the combination of the following features is especially advantageous: the base body has a cylindrical portion and a bent portion communicated with the cylindrical portion, the extrusion spout being communicated with the bent portion. The piston, in turn, is at least partially bendable, preferably in its front region which can extend into the arcuate or bent portion of the base body while, however, the diameter of the piston remains unchanging. The bending ability permits the desired arcuate shaped guiding of the piston in this region to occur without the guiding capability otherwise being negatively impacted.

The piston can, in particular, be comprised of such a length that tilting thereof is foreclosed. Surprisingly, the combination of the cylindrical and bent portions of the base body results in a substantially friction-free guiding of the piston within the base body, whereby it is to be understood that, in accordance with the present invention, it is advantageous if the elastic or bendable portion of the piston is comprised of the same length as the bent portion of the base body, while the non-bendable portion of the piston comprises a length such that, in any event, a clamping of the piston is reliably foreclosed. For example, the length of the piston can be two or three times that of the inner diameter of the cylindrical portion of the base body.

In accordance with the present invention, a disturbance-free guiding of the piston is possible in spite of the configuration of the ergonomically favorable bent region of the cartridge.

In accordance with the present invention, it is possible to configure a portion of the cartridge with a decidedly strong bending configuration. For example, the bent portion of the base body can be configured with an arc angle of more than 30°, preferably an arc angle of around 45°, or, in selected individual cartridges, with an arc angle of 60°. Thereafter, an arc angle along which the extrusion spout extends of a further 30° can be provided, wherein the composite or total arc angle can amount to, for example, 75° or even 90°.

This inventive solution has the advantage that the extruded mass is substantially completely extruded downwardly so that even difficult to reach hollow volumes can nonetheless be filled in a good manner.

Surprisingly, in connection with the present invention, although the configuration thereof provides a cylindrical portion of the base body, it is possible to achieve an extrusion direction that is decidedly strongly downwardly lowered, whereby, in accordance with the present invention, with the configuration of a bent extrusion spout with a decidedly reduced arc radius, the mass extruded therefrom extends in an arcuate extruded strand.

In a further advantageous embodiment, it is provided that the inner diameter of the bent portion of the base body corresponds to the inner diameter of the linear portion of the base body and, as well, the outer diameters of the two portions of the base body—at least in the transition area of the two portions of the base body—correspond to one another.

In a further advantageous embodiment, it is provided that the length of the extrusion spout is somewhat reduced to, for example, around 30% less than the length of the bent portion of the base body and it is provided that the inner diameter of the extrusion spout is less than the inner diameter of the bent portion of the base body such as, for example, approximately one-half of the inner diameter of the bent portion of the base body.

In an advantageous embodiment, it is provided that the base body comprises a substantially cylindrical portion and a bent portion that is communicated with the extrusion spout, and the piston is at least partially bendable.

In a further advantageous embodiment, it is provided that the base body is suitably configured for the receipt of the piston of a respective extrusion drive device in which the base body can be received or to which the base body can be secured, and the piston is configured to be bendable at its front region but, however, is configured to have a diameter that remains constant during the activation of the piston.

In yet another advantageous embodiment, it is provided that the extrusion spout is bent and the bend of the extrusion spout is substantially axially congruent with the bent portion of the base body and, in particular, has the same arc radius.

In an additional embodiment, it is provided that the extrusion spout comprises an inner channel having an inner diameter that is, relative to the base body, clearly reduced and, in particular, is less than half of the diameter of the base body, as well as a clearly reduced outer diameter, and it is further provided that, in particular, the outer diameter of the extrusion spout extends in a conical configuration toward the tip of the spout.

In a further advantageous embodiment, it is provided that the cartridge is configured as a one-time use cartridge and is filled with a mass.

In a further additional embodiment, it is provided that the inner diameter of the bent portion of the base body is constant along the extent of the bent portion.

In yet another advantageous embodiment, it is provided that the bent portion of the base body extends along an arc angle of more than 20° and less than 90°, in particular extends along an arc angle of approximately 45°.

In a further preferred embodiment, it is provided that the arc radius of the bent portion of the base body is substantially constant along the entire length of the bent portion of the base body.

In yet another additional preferred embodiment, it is provided that the bent portion of the base body, at the location at which it communicates with the cylindrical portion of the base body, has an arc radius larger or smaller than the arc radius of the remainder portion of the bent portion of the base body and it is provided that the arc radius reduces at an arc angle of 2° to 20° to a constant arc angle.

In a further advantageous embodiment of the present invention, it is provided that the bent portion of the base body comprises an arc radius of 3 to 20 times and, in particular, approximately 5 times, the inner diameter of the bent portion of the base body.

In an additional advantageous embodiment of the present invention, it is provided that the free end region of the first portion of the base body is provided with a load engaging element that, at the least, is configured as a positive connection element. The load engaging element is in the form of a flange that extends radially over the outer diameter of a portion of the base body, an outer threaded structure that is located on the outer side of a portion of the base body, or a back cut structure.

In a modified advantageous embodiment of the present invention, it is provided that the first cylindrical portion of the base body is disposed between the second portion of the base body and the spout.

In a further advantageous embodiment, it is provided that at least the region of the first portion of the base body that transitions into the second portion of the base body is transparent in that it is, preferably, configured of a transparent material or, especially, in that it is color transparent or is provided with a transparent colored coating.

In this embodiment, the colored material or the colored coating can have the capability to prevent the passage of light therethrough having a wavelength between 350 and 500 nm. The cylindrical first portion of the base body and the extrusion spout are comprised of a light non-transmitting material so that the light sensitive dental material can be securely stored therein.

The extrusion spout is preferably configured of a bent shape and comprises the same bending configuration as the second portion of the base body.

Preferably, the inner channel of the extrusion spout has a constant diameter along its entire length, or the largest open width of the inner channel enlarges toward the free end of the spout.

In an additional advantageous embodiment, it is provided that the majority portion of the piston is, in the non-pressed condition of the cartridge, in the first portion of the base body. Additionally, the piston is preferably comprised of a colored material. However, the piston can have a colored coating drawn thereover, or can be provided with a visually recognizable marking. In this embodiment, it is advantageous if the first portion of the base body comprises at least one lateral through opening, preferably in the form of a longitudinal slot, whose width as viewed perpendicular to the longitudinal extent of the first portion of the base body is smaller than the inner diameter of the base body, whereby the first portion of the base body and the piston preferably comprise displays that indicate the full condition of the cartridge and that cooperate with one another. The longitudinal slot comprises, in particular, a width of 10 to 30%, preferably approximately 20%, of the inner diameter of the base body.

It is also further provided in an embodiment of the present invention that the outlet opening of the extrusion spout can be closed via a cover cap that, in particular, is the same color as the piston and/or as the first portion of the base body. The cover cap can, in particularly, be comprised of an elastic material and can easily be accommodated to the configuration of the spout.

The base body and/or the extrusion spout and/or cover cap can be configured of plastic.

In a further advantageous embodiment, it is provided that the outer contour of the second portion of the base body tapers in the direction toward the spout.

In a further advantageous embodiment, it is provided that the extrusion spout has an inner diameter that, adjoining the base body, has an inner channel with a diameter of approximately 10 to 60%, preferably 20 to 40%, and especially approximately approaching 30%, of the inner diameter of the bent portion of the base body.

In a further advantageous embodiment, it is provided that an outlet opening of the second portion of the base body facing the extrusion spout lies in a plane that is at an angle of between 15 to 60° relative to a plane perpendicular to the longitudinal direction of the first portion of the base body.

In an additional advantageous embodiment, it is provided that the extrusion spout is configured with a linear configuration.

In yet an additional advantageous embodiment, it is provided that the extrusion spout is configured as an elastic element.

In a further additional embodiment, it is provided that the inner diameter of the base body expands in the direction toward the free end of the first portion of the base body.

### BRIEF DESCRIPTION OF THE FIGURES

Further advantages, details, and features of the present invention are set forth in the hereinafter following description of several embodiments of the invention having reference to the figures of the drawings, in which:

FIG. 1 is a schematic side elevational view of one embodiment of the cartridge of the present invention;

FIG. 2 is a sectional schematic side elevational view of the one embodiment of the cartridge shown in FIG. 1;

FIG. 3 is a partial sectional side elevational view of the one embodiment of the cartridge shown in FIGS. 1 and 2 and showing, additionally, the operational connection of the cartridge to an extrusion drive device;

FIG. 4 is a side elevational view of another embodiment of the cartridge of the present invention;

FIG. 5 is a side elevational view of an additional embodiment of the cartridge of the present invention;

FIG. 6 is a side elevational view of a further embodiment of the cartridge of the present invention;

FIG. 7 is an enlarged sectional side elevational view of a detail of yet another embodiment of the cartridge of the present invention;

FIG. 8 is a sectional elevational view of a detail of yet another additional embodiment of the cartridge of the present invention;

FIG. 9 is an enlarged sectional side elevational view of a portion of the one embodiment of the cartridge of the present invention shown in FIGS. 1, 2, and 3; and

FIG. 10 is a side elevational view of a further additional embodiment of the cartridge of the present invention.

### DETAILED DESCRIPTION

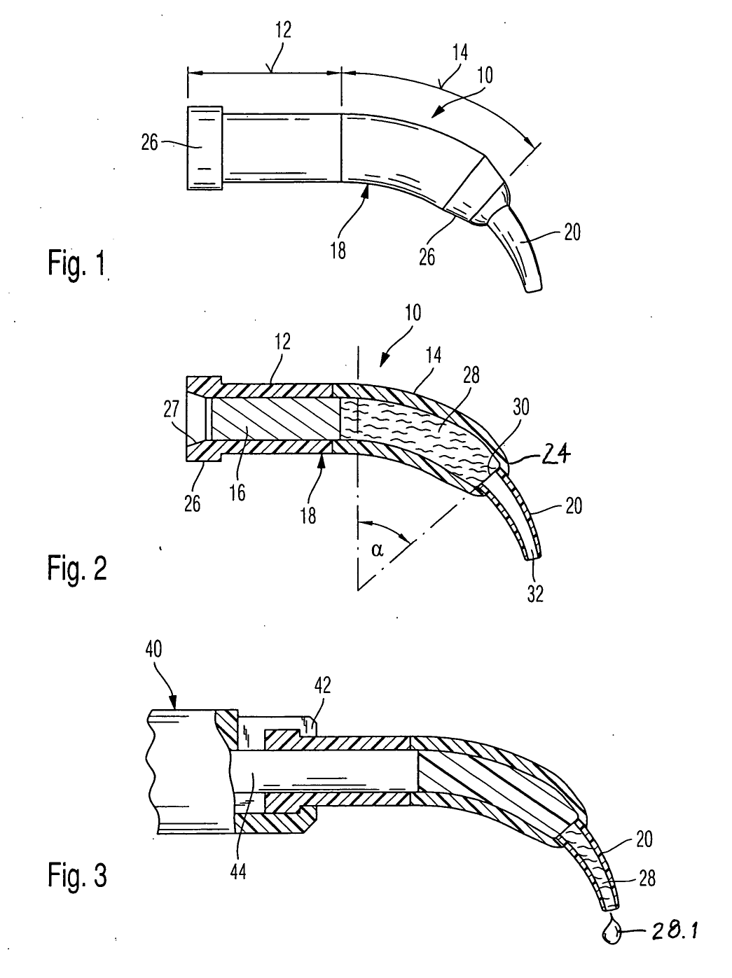

The cartridge 10 shown in FIG. 1 comprises a first portion 12 and a second portion 14 that communicate with one another and that extend flush relative to one another—that is, in the region of their transition with one another, the two portions have the same inner diameter and the same outer diameter.

As can been seen in FIG. 2, the cartridge 10 is hollow in its interior and is configured for the receipt therein of a piston 16, as well as a dental material 28, which is shown in its non-extruded view in the view.

The first portion 12 and the second portion 14 of the cartridge together form the base body 18 of the cartridge.

An extrusion spout 20 is provided on the front end of the second portion 14 of the base body, the outer diameter of the extrusion spout 20 being smaller than the outer diameter of the second portion 14 of the base body and the inner diameter of the extrusion spout being smaller than the inner diameter of the second portion 14 of the base body.

In the illustrated embodiment, the first portion 12 of the base body is substantially linear and, in fact, is linear along its inner and outer dimensions, and the second portion 14 of the base body is bent. Additionally, the extrusion spout 20 is bent as well and, in fact, is bent in the same sense as the second portion 14 of the base body. Preferably, the second portion 14 of the base body and the extrusion spout 20 are congruently bent—that is, the bent longitudinal middle axis of the second portion 14 of the base body and the bent longitudinal middle axis of the extrusion spout 20 coincide with one another at their transition locations. Correspondingly, a bending radius a, seen in FIG. 2, is provided that likewise has a comparatively reduced value. In the illustrated embodiment, the bending radius is 5 times the inner diameter of the second portion 14 of the base body.

An outer contour 24 of the second portion 14 of the base body that tapers downwardly is provided in the transition region between the second portion 14 of the base body and the spout 20. The inner diameter of the second portion 14 of the base body is, however, constant in this region, so that solely the wall thickness of the base body 18 is reduced thereat.

As can be seen in FIG. 1, a load engaging element 26 is configured on the respective end of the first portion 12 of the base body that is disposed in opposition to the second portion 14 of the base body. An introduction cone 27 is disposed interiorly thereat, so that the inner diameter of the first portion 12 expands in the direction toward its free end region.

The load engaging element 26, in the embodiment shown in FIGS. 1, 2, and 3, is configured as an encircling flange that is deployable in a corresponding receipt region of an extrusion drive device and serves to maintain the cartridge in its position in opposition to forces in the extrusion direction applied thereagainst.

As can been seen in FIG. 2, the manner in which the piston 16 extends in the first portion 12 of the base body in the outlet position is shown. The piston 16 is, in the illustrated embodiment, comprised entirely of an elastic material such as, for example, an elastomer. The piston can, also, be instead comprised of two or more different materials. The piston is disposed in the interior space of the first portion 12 of the base body in a sealed off relation thereto, and projects somewhat into the second portion 14 of the base body.

In contrast, in the extrusion condition, the second portion 14 of the base body is completely filled with a dental mass 28. The dental mass is present at an outlet opening 30 of the second portion 14 of the base body that forms the transition to the spout 20.

As can be seen in FIG. 2, an inner channel 32 of the spout 20 is formed with an inner diameter clearly reduced relative to the inner diameter of the second portion 14 of the base body.

In the illustrated embodiment, the second portion 14 of the base body is comprised of a black and light non-transmissive material, while the first portion 12 of the base body, which guides therein the piston 16, is configured of a transparent material. This material can consist of either one transparent material or a colored material and a transparent color coating. The colored material or colored coating chosen shall have the capability of preventing the passage of light having a wavelength of 350 nm. to 500 nm. The piston 16, which projects somewhat into the second portion of the base body, prevents the incidence of light onto the dental mass 28.

In the end user delivery condition, it is preferable that the extrusion spout is closed with a cover cap (not illustrated) that closes off the front tip of the extrusion spout so that the extrusion spout can maintain a light-protected and anti-air penetration sealed off condition during storage.

A not-further illustrated extrusion drive device 40 is provided for extruding the mass from the cartridge, the extrusion drive device securely guiding and receiving the cartridge in its receipt region 42.

A correspondingly suitable extrusion drive device is shown, for example, in FIG. 6 of U.S. Pat. No. 6,524,103.

The extrusion drive device 40 comprises a drive piston 44 that is displaceable in the direction of the piston 16. The diameter of the drive piston 44 is somewhat smaller than the diameter of the piston 16. Via the operation of the extrusion drive device 40, the piston 16 is displaced in the direction of the second portion 14 of the base body. As the piston is at least partially bendable, it accommodates itself to the form of the bent portion 14 and, at the same time, presses the dental mass 28 out of the cartridge 10 via the spout 20.

A dental mass strand 28.1 is produced via the relatively strong bending of the bent portion 14 of the base body and the extrusion spout 20, this strand moving practically vertically downwardly and being, as well, easily positionable relative to difficult to reach locations.

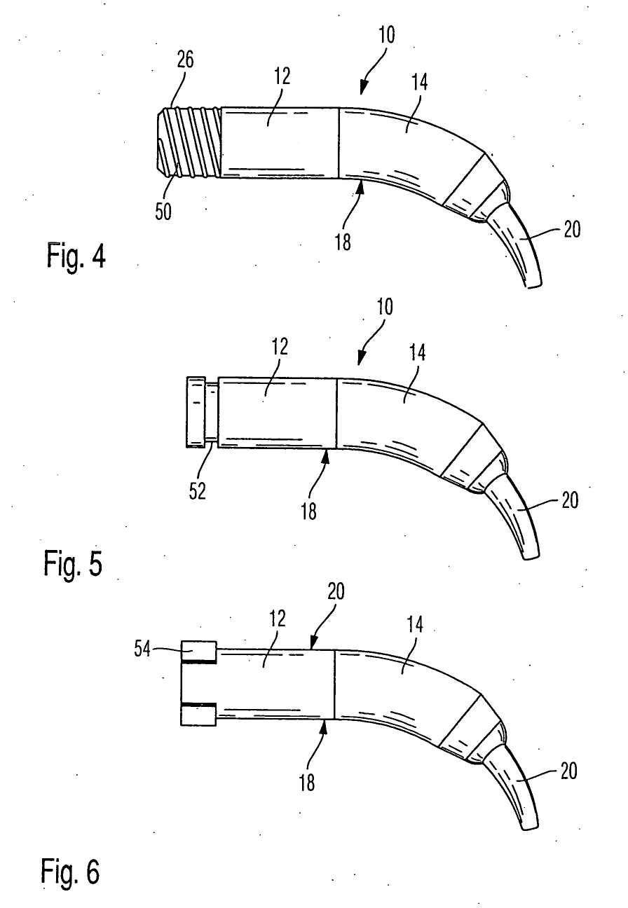

Other embodiments of the inventive cartridge is shown, respectively, in FIGS. 4, 5, and 6. In the embodiment shown in FIG. 4, the load engaging element 26 is configured as an element 50 having outer threads; in the embodiment shown in FIG. 5, the load engaging element is configured as an encircling groove 52, that, to this extent, makes possible the configuration of a back cut structure and, in the embodiment shown in FIG. 6, the cartridge is provided with a bayonet closure or a Luer lock configuration having engaging elements 54 that is, in any event, deployable to create a positive connection between the extrusion drive device 40 shown in FIG. 3, and the cartridge 10.

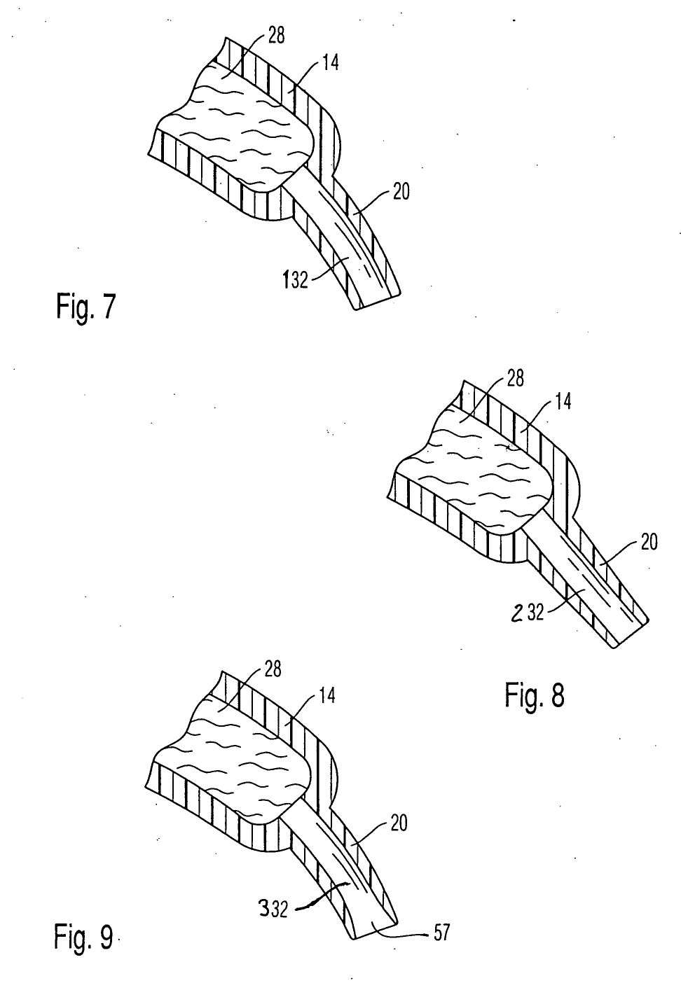

Various configurations of the extrusion spout 20 are respectively shown in FIGS. 7, 8, and 9. In the configuration shown in FIG. 7, an axially congruently bent extrusion spout 20 is provided whose inner channel 132 has a constant inner diameter.

In the configuration shown in FIG. 8, in contrast, a spout 20 is shown that has a constant inner diameter in the channel 232 but which, however, in contrast to the configuration shown in FIG. 7, extends linearly.

This solution is of interest if the bent portion 14 of the base body is strongly bent so that a further deviation or turning of the extruded dental mass strand is not required.

The configuration shown in FIG. 9 shows, in contrast to the above-noted configurations, that the inner channel 332 of the spout 20 is widened in its interior on the end thereof at the communication mouth region 57. The guiding of the dental mass strand is permitted greater tolerance via this widening out of the inner channel. Additionally, if the dentist during the extrusion operation of the cartridge and the introduction of the dental mass into the cavity to be filled makes small movements of the extrusion drive device 40, the dental mass strand does not break off so easily as it, on its outlet side, is guided with a predetermined amount of play via the extrusion spout 20.

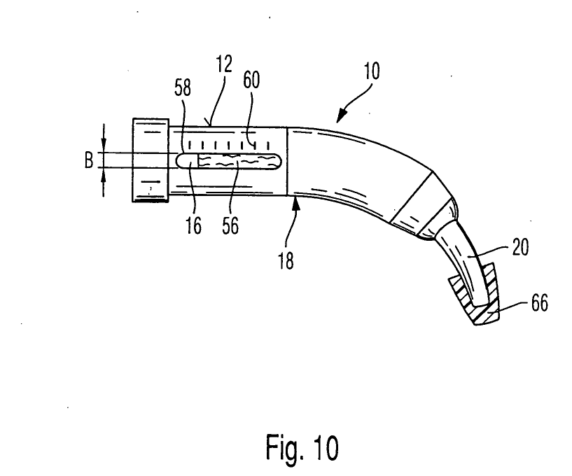

As shown in FIG. 10, a full condition display 56 can be configured for the cartridge. In this connection, a side through opening in the form of a longitudinal slot 58 is provided that extends practically along the entire length of the first portion 12 of the base body. The width of the opening, B, is less than the inner diameter of the base body. The longitudinal lateral through opening or slot 58 permits observation of the back side or the back of the piston 16 or a corresponding marking on the piston 16. The piston will either be comprised of a colored material or have a colored coating or have visually recognizable markings. Additionally, a measurement scale 60 is provided adjacent to the longitudinal slot 58 on the linearly extending portion 12 of the base body so that, via the arrangement of a corresponding marking on the piston 16, the extent to which the piston 16 has already been displaced can be determined.

It is shown, additionally, in FIG. 10 that the front region of the spout 20 can, in accordance with the present invention, be selectively covered and uncovered via a cover cap 66. The cover cap 66 preferably is comprised of a decidedly soft and, thus, correspondingly good sealing, material that is, preferably, opaque as well and can be accommodated in its color to that of the piston 16 and/or to that of the first portion 12 of the base body. At least one of the base body, the extrusion spout and/or the cover cap is comprised of plastic.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A cartridge for storing and applying a mass, especially a mass of dental material, comprising:
a tube-shaped base body having a first cylindrical portion and a second bent portion and having one end and an opposite end, the base body having an inner diameter;
an extrusion spout connected to the one end of the base body, the opposite end of the base body being operable to be positively engaged by a load engaging element that itself cooperates with an extrusion drive device that can be activated to perform an extrusion operation in which a mass in the cartridge is extruded from the extrusion spout, the extrusion spout having an inner diameter; and
an axially displaceable piston disposed in the base body and operable to be displaced by operation of the extrusion drive device such that the piston, as it moves relatively within the first cylindrical portion and the second bent portion of the base body, pushes the mass out of the base body into the extrusion spout and therebeyond, the inner diameter of the extrusion spout being smaller than the inner diameter of the base body and the piston being at least partially bendable.

2. A cartridge according to claim 1, wherein a free end region of a portion of the base body, in particular the first portion, is provided with the load engaging element.

3. A cartridge according to claim 2, wherein the load engaging element is in the form of at least one positive connection element in the form of a selected one of a radially projecting flange, in particular a flange that radially projects over the outer diameter of a portion of the base body, an outer threaded structure that is located on the outer side of a portion of the base body, and a back cut structure.

4. A cartridge according to claim 1, wherein a bent second portion of the base body is between the first cylindrical portion of the base body and the spout.

5. A cartridge according to claim 1, wherein the first portion of the base body includes a section that is communicated with the second portion of the base body and is configured as a transparent portion.

6. A cartridge according to claim 5, wherein the transparent portion is comprised of a transparent material.

7. A cartridge according to claim 6, wherein the transparent material is a selected one of a colored material and a transparent colored coating.

8. A cartridge according to claim 7, wherein the selected one of the colored material and the colored coating prevents the passage of light therethrough having a wavelength of between 350 to 500 nm.

9. A cartridge according to claim 7, wherein the colored material or the colored coating is translucent for light with a wavelength of 350 nm to 500 nm.

10. A cartridge according to claim 1, wherein the extrusion spout is configured as a bent piece.

11. A cartridge according to claim 10, wherein the extrusion spout has the same bending configuration as the second portion of the base body.

12. A cartridge according to claim 1, wherein the extrusion spout includes an inner channel that has a constant diameter along its entire length.

13. A cartridge according to claim 1, wherein the largest inner extent of an inner channel of the extrusion spout enlarges in the direction toward a free end of the extrusion spout.

14. A cartridge according to claim 1, wherein the principal portion of the piston is disposed, in a non-extruded condition of the cartridge, in the first portion of the base body.

15. A cartridge according to claim 1, wherein at least the respective end portion of the piston that is disposed toward the extrusion spout is configured as a bendable portion.

16. A cartridge according to claim 1, wherein the piston is a selected one of a piston comprised of a colored material, a piston covered over with a colored coating, and a piston having a visually recognizable marking.

17. A cartridge according to claim 1, wherein the first portion of the base body comprises at least one lateral through opening, whose width—as viewed perpendicularly to the longitudinal extent of the first portion of the base body is smaller than the inner diameter of the base body.

18. A cartridge according to claim 1, wherein an outlet opening of the extrusion spout is closeable via a cover cap.

19. A cartridge according to claim 18, wherein the cover cap is comprised of the same color as at least one of the piston and the first portion of the base body.

20. A cartridge according to claim 1, wherein the first portion of the base body and the piston are provided with indicators that cooperate with one another to indicator filling state.

21. A cartridge according to claim 1, wherein at least one of the base body, the extrusion spout, and the cover cap is comprised of plastic.
